(19) United States
(12) Patent Application Publication
(10) Pub. No.: US 2013/0043079 A1
(43) Pub. Date: Feb. 21, 2013

(54) Multi-Scale System and Method

(71) Applicants: Brian Levin, Valencia, CA (US); Ryan Borland, Ridgecrest, CA (US)

(72) Inventors: Brian Levin, Valencia, CA (US); Ryan Borland, Ridgecrest, CA (US)

(21) Appl. No.: 13/589,050

(22) Filed: Aug. 17, 2012

Related U.S. Application Data
(60) Provisional application No. 61/524,853, filed on Aug. 18, 2011.

(51) Int. Cl. G01G 19/40

(52) U.S. Cl. 177/1; 177/25.13

(57) ABSTRACT

Exemplary embodiments of a multi-scale system and method comprise at least two scale elements with respective scale readouts and control logic. The control logic may be configured to activate the scale elements and weight readouts concurrently throughout a selected period of time as a result of a single transaction. The system may preferably be operated within a travel service facility, such as an airline or bus terminal, for allowing a traveler to simultaneously and independently weigh multiple pieces of luggage, and redistribute the contents therebetween prior to checking the luggage with any travel service within the travel service facility. Each scale platform may include a cage element adapted to provide lateral support and stabilization for the object placed on the respective scale platform. The system may include a network connection by which the system can be remotely controlled, monitored and updated from an off-site location.

### RELATED APPLICATIONS

This application claims the benefit of U.S. Provisional Application No. 61/524,853, filed on Aug. 18, 2011, the contents of which are incorporated by this reference in its entirety for all purposes as if fully set forth herein.

### TECHNICAL FIELD

The present invention relates generally to systems and methods for weighing luggage items. More particularly, the invention relates to systems and methods to enable travelers to weigh luggage items prior to their trip onboard a carrier, such as an airline.

### BACKGROUND

Excess baggage fees, particularly in the airline industry, represent a continued source of expense, frustration and inconvenience for travelers. Travelers often seek to verify that their luggage is weight-compliant before checking in for their flight or other mode of travel by a carrier. What is needed is a more convenient, quick and cost effective way for travelers to determine and redistribute weight between multiple pieces of luggage simultaneously.

### SUMMARY

Certain deficiencies of the prior art are addressed by the provision of embodiments of a multi-scale system and method. A multi-scale system may comprise at least two scale elements with respective weight readouts and control logic. Each scale element may have a scale platform and may be adapted to independently sense the weight of an object, such as a piece of luggage, placed on the respective scale platform. Each weight readout may be operatively associated with a respective one of the scale elements. The control logic is generally configured to activate the scale elements and the weight readouts concurrently throughout an activation period as a result of a single transaction, such as a single payment, swipe of an identification card, pressing of a single button, placement of a piece of luggage on one of the scale platforms, or the like.

In certain preferred embodiments of the system, the weight readouts may each be independent pieces of display hardware. Alternatively, the system may include a graphic display and the weight readouts may each be presented as independent locations on the graphic display. Embodiments of the system may include a payment interface element by which the payment can be made.

In particular preferred embodiments, the system may include a base element for maintaining the scale element at, for example less than two feet from one another, and in some cases, no greater than a distance of one foot from one another. Such a base element may also maintain a substantially fixed orientation with respect to one another. In embodiments with a base element, the base element may include at least one ramp element adapted to facilitate placement of an object onto and off of a respective scale platform without requiring a user of the system to lift the full weight of the object.

In certain embodiments, each of the scale platforms may include a cage element. Each cage element may be adapted to provide lateral support and stabilization for the object, such as a piece of luggage, placed on the respective scale platform. Each such cage element may be configured to act as a substrate upon which information is displayed to a user or potential user of the system. Such information may include, for example, advertising, system usage instructions or system branding.

A preferred embodiment of a multi-scale method, may comprise acquiring a multi-scale system as described, for example, herein, and operating the system within a travel service facility. Preferably, the system may be located for allowing a traveler to use the system to simultaneously independently weigh two pieces of luggage and redistribute the contents therebetween prior to checking the pieces of luggage with any travel service within the travel service facility.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of an embodiment of a multi-scale system;

FIG. 2 is a diagrammatic enlarged partial view of an embodiment of a multi-scale system, illustrating examples of a weight readout, calibration readouts and a payment interface element;

FIG. 3 is a diagrammatic side view of the embodiment of FIG. 1;

FIG. 4 is a further diagrammatic side view of the embodiment of FIG. 1;

FIG. 5 is a diagrammatic top view of the embodiment of FIG. 1;

FIG. 6 is a diagrammatic enlarged view of detail 6 in FIG. 4;

FIG. 7 is a diagrammatic front view of the embodiment of FIG. 1; and

FIG. 8 is a diagrammatic partially exploded view of the embodiment of FIG. 1.

### DETAILED DESCRIPTION OF THE PREFERRED EMBODIMENTS

Referring now to the drawings, like reference numerals designate identical or corresponding features throughout the several views.

Referring to the various Figures, illustrated generally at 100 are one or more embodiments of a multi-scale system. A system 100 may include at least two scale elements 104, wherein the scale elements 104 may be adapted to sense the weight of objects independently of one another. Each scale element generally includes a scale platform 136, which is typically the surface upon which the object to be weighed is placed. In accordance with functional and aesthetic preferences, the scale platform 136 may take on a number of shapes, for example, from squares and rectangles to circles and more organic shapes. The embodiment illustrated in FIG. 5, for example, has scale platforms 136 which are generally square. A scale platform 136 may have a scale length 124 and a scale width 126. In certain embodiments, for example, the scale length 124 and scale width 126 may each be approximately 30 inches. Typically, the scale platforms 136 have dimensions which accommodate most common sizes of luggage items. The terms luggage items, luggage and baggage may be used interchangeably herein. Depending upon the particular embodiment, the scale elements 104 may be rated to carry up to 500 lbs., and may be classified as “legal for trade.”

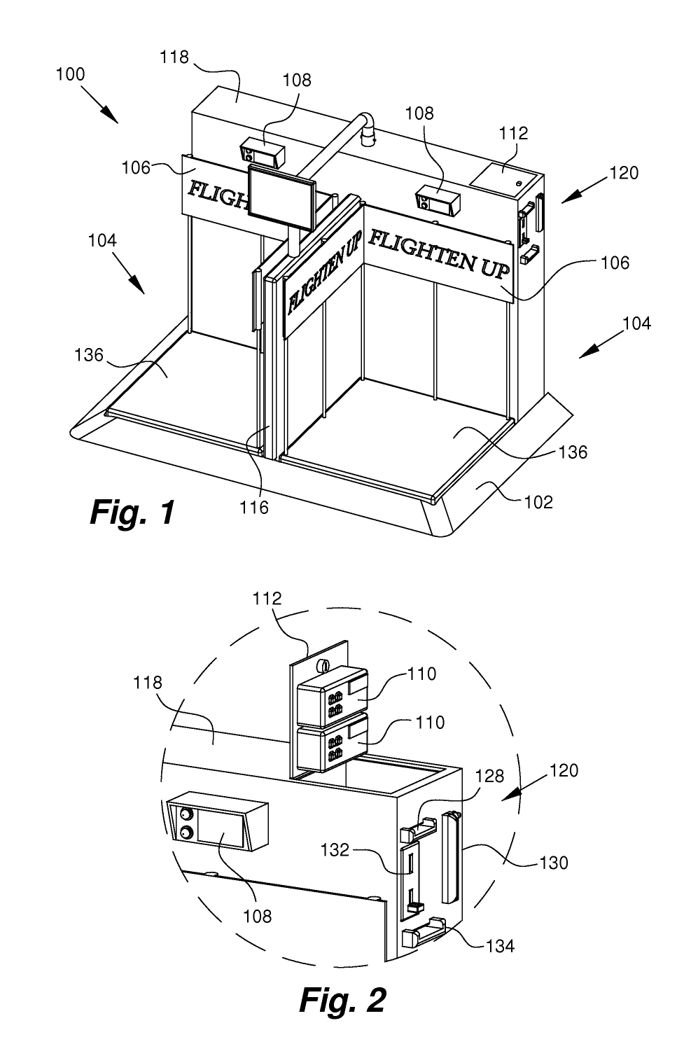

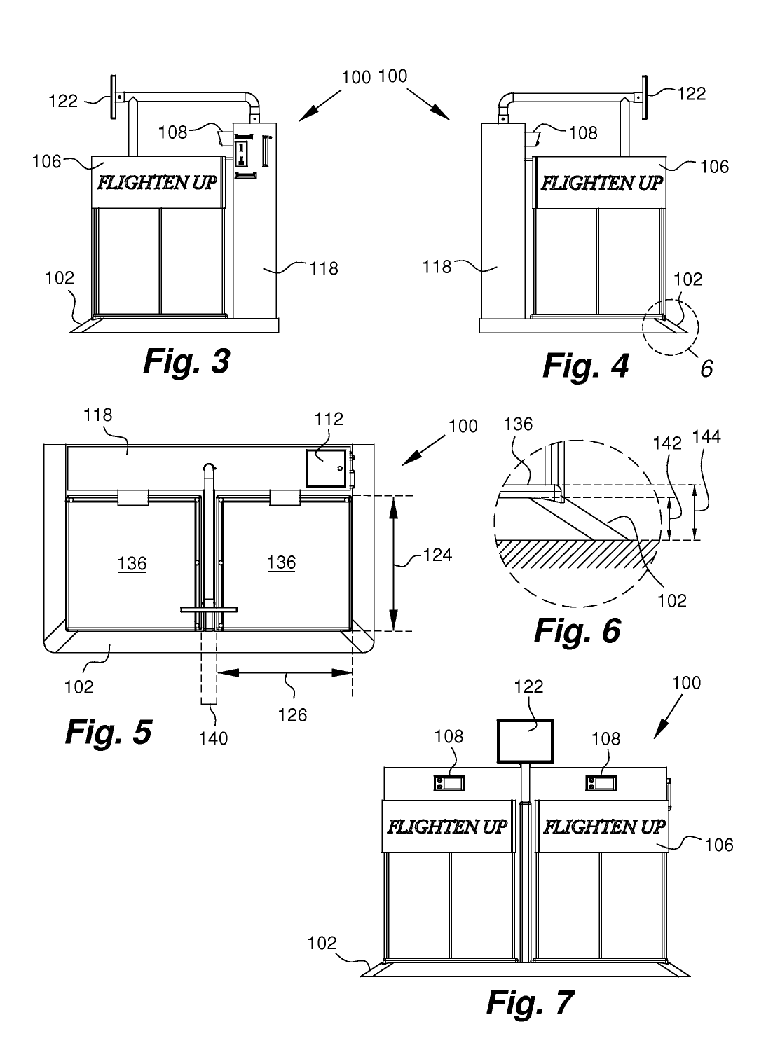

Referring to FIG. 1 for illustration, each scale element 104 may be associated with a separate weight readout 108, which is configured to display the weight of an object resting on the respective scale element 104. In certain embodiments, the weight readouts 108 may be, for example, two independent pieces of display hardware, or two independent locations on the same graphic display. Referring to FIG. 2 for illustration, embodiments may include a calibration readout 110 electrically connected to each scale element 104 or its respective weight readout 108. The calibration readouts 110 may each include a calibration interface, such as one or more buttons, that allows a technician to conveniently re-calibrate the respective scale element 104 or weight readout 108 at regular intervals. The calibration readouts 110 may be secured from public access by way of a calibration access door 112. Such a calibration access door 112 may typically be hinged and lockable.

Preferred embodiments are configured to allow all of the scale elements 104 and weight readouts 108 of the system 100 to become and remain concurrently active by virtue of a single transaction, such as a single payment being made by way of, for example, a payment interface element 120. Such concurrent activation will typically allow a user, such as a traveller at an airport, to receive for a period of time a simultaneous weight readout for two or more separate pieces of luggage. This allows the user time to shift items to, from or between the pieces of luggage while continuously receiving a real-time readout for each separate piece of luggage. As a result, for a relatively small payment prior to checking in, the user can avoid the imposition of large excess baggage weight fees.

In particular embodiments, the system's control logic may be configured to activate the scale elements 104 and the weight readouts 108 concurrently throughout an activation period as a result of a single transaction. Such transaction may be, for example, a single payment, swipe of an identification card, pressing of a button, placement of a piece of luggage on one or both of the scale platforms, or the like.

Referring to FIGS. 1 and 2, a payment which activates all of the scale elements 104 of a system 100 is typically made by way of a payment interface element 120. A payment interface element 120 may include one or more of such features as a bill feeder 128, a payment card interface 130, a coin interface 132 and a receipt dispenser 134. It is envisioned that various manufacturing, functional, aesthetic and ergonomic considerations will dictate where such a payment interface element 120, or constituent interfaces and dispensers, will be located on various alternative embodiments of a system 100. Depending upon the particular embodiment, the bill feeder may accept $1, $5, $10 and $20 bills, as well as, in some cases, denominations of foreign currency. A system 100 may be adapted to process payment via credit card, debit card, cash or the like. In certain embodiments, alternative forms of payment may be accepted as well, including voucher cards and credits from an airlines, taxis, hotels or other venders. In some embodiments, it is envisioned that such vouchers or credits may be made accessible by the user via a network interface and an auxiliary display such as that shown at 122.

Referring again to FIG. 5, in embodiments having two scale elements 104, it may be preferred that the distance 140 between each of the scale elements 104 is no greater than approximately one foot. In certain preferred embodiments, the scale elements 104 may be connected to or otherwise collocated with a base element 114. The base element 114 may provide structural support for displays and interfaces, secure proper spacing and orientation between the scale elements 104, and safely and aesthetically house wiring and electronics associated with the system 100. Referring to FIG. 7, in particular embodiments, the base element 114 may comprise the ramp elements 102, and have a floor portion 146, a tower portion 118 and a divider portion 116. In certain embodiments, the base element 114 or scale elements 104 may have adjustable feet or similar features to provide for improved leveling on an uneven surface.

Referring to FIG. 7, a scale element 104 may include a cage element 106 affixed to the scale platform 136 by way of, for example, weld joint, adhesive, threaded engagement, tongue and groove, snap interface or other conventional generally rigid securement means. In such embodiments, the cage element 106 may typically be adapted to provide lateral support or stabilization for an object being weighed on the scale element 104, such as a piece of luggage. Consequentially for example, in embodiments with a base element 114 which includes one or more of a divider element 116 and a tower portion 118, a cage element 106 may be adapted to prevent a piece of luggage from resting or otherwise contacting the divider element 116 or the tower portion 118 while the luggage is being weighed. As a result, a cage element may provide additional convenience and ease-of-use for a user of the system 100, while preventing a disruption of the accuracy of the weight measurement being taken by the respective scale element 104. Additionally, the scale element 104 or its respective weight readout 106 are typically configured to be calibrated to account for the weight of the respective cage element 106. Such calibration may be performed, for example, by way of a respective calibration readout 110. A cage element 106 may be formed, for example, from solid planar elements, bars, mesh, grating, vertical or horizontal slats, a combination thereof, or the like. A cage element 106 may also act as a substrate upon which advertising, product use, product brand or other information may be displayed.

Certain preferred embodiments may include a ramp element 102 to facilitate the placement of a piece of luggage onto a respective scale platform 136, and removal therefrom without having to fully lift the respective piece of luggage. Referring to FIG. 6, in typical such embodiments, the ramp height 142 may be less than the platform height 144. This adaptation may help prevent any portion of the luggage from resting on the ramp element 102 and thereby skewing the weight measurement. Further, in embodiments having ramp elements 102, the ramp element may have a lateral clearance from the respective scale platform 136. This clearance may be, for example, approximately ⅛ to ½ inches, and may help ensure that the scale platform can shift slightly in the lateral direction without the weight measurement being interfered with by way of contact between the scale platform 136 and respective ramp element 102. As shown in the embodiment of the several Figures, in particular embodiments, a ramp element 102 may wrap substantially around the front and side portions of the system 100. In other embodiments, a ramp element 102 may only be present on one side of each scale platform 136. In embodiments in which one or more of the scale platforms 136 have curved or rounded sides, a ramp element 102 may substantially conform to the shape or contour of the respective scale platform 136.

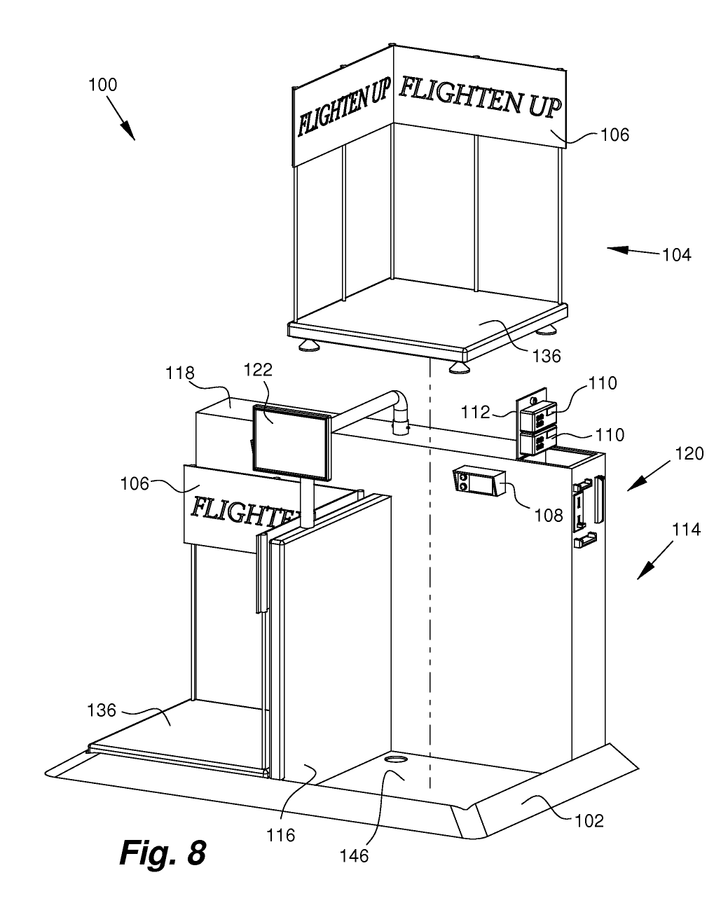

Referring to FIG. 8, particular embodiments may include an auxiliary display or touch screen panel element 122. Information such as carrier-specific weight regulations and pricing structure, flight schedules, advertisement, payment information and luggage weight may be displayed on panel element 122. Further, it is envisioned that in certain embodiments panel 122 may perform the function of the weight readouts 108. In particular embodiments, the panel element 122 may also perform the role, in whole or in part, of the payment interface element 120. For example, embodiments of a panel element 122 may include a payment card interface (similar to that shown at 130), and may display payment information relating to the payment transaction. Some such embodiments may also provide currency conversion information. Examples of a panel element 122 may include a touch screen allowing, for example, a user to input payment, airline, or other information. In some such embodiments, particularly those which accept credit or other payment cards, the system 100 may be adapted to allow the user to pre-select or extend the length of time the system remains active during their session.

Certain embodiments of a system 100 may be adapted to be electrically interconnected or networked with other systems 100. In network capable embodiments, the networking may be by way of cable, wireless router, or other similar means. Further, particular embodiments may be configured to communicate with one or more centralized processors or databases controlled or accessed by an operator of a travel service facility in which the system may be located. Such embodiments may thereby allow for more efficient centralized control and monitoring of multiple systems distributed at various locations within the travel service facility. Such embodiments may also allow the operating facility to more conveniently collect payment and usage data from each system in order to produce statistics useful to their business operations. Such network-capable embodiments may also allow an off-site service facility to monitor the performance of the system to determine, for example, when a system goes unexpectedly off-line or requires calibration. Additionally, in embodiments which may provide currency conversion information to a user, such information may be updated substantially in real time by way of a network connection.

In operation of one example embodiment, a user may approach the system 100, and make a payment to activate the system for a specific amount of time. The user may then lift or roll a piece of luggage onto each of the scale platforms 136 of respective scale element 104. The user may then observe the weight of each piece of luggage by way of the respective weight readouts 108, and remove, insert and shift items between the respective pieces of luggage until each weight readout 108 reaches a weight below, for example, the threshold at which the carrier would charge an excess weight fee. If the luggage continues to be overweight, in some cases a user may have the option of buying a compact piece of luggage through, for example, a vending machine placed nearby the system 100. Such pieces of luggage may be guaranteed to be cable of carrying up to 50 lbs. and comply with carry on dimensions. Once the user has completed the redistribution of the contents of their luggage, they may lift or roll the luggage off of the scale platforms, press a finish button and receive a receipt. In certain embodiments, a receipt will not be printed until the scales have a zero reading or the time limit has expired.

In accordance with various business arrangements, systems may be implemented by a travel center partner, such as, for example, an airline terminal, other transportation service or hotel, by way of profit sharing or lease arrangement. In this regard, the system may become a revenue generating solution that allows the partner to focus on running their core business while collecting a portion of the profits from the operation of the system.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A multi-scale system comprising:
at least two scale elements, each scale element having a scale platform and being adapted to independently sense the weight of an object placed on the respective scale platform;
at least two weight readouts, each weight readout being operatively associated with a respective one of the at least two scale elements; and
control logic configured to activate the scale elements and the weight readouts concurrently throughout an activation period as a result of a single payment.

2. A multi-scale system as defined in claim 1 in which the weight readouts are each independent pieces of display hardware.

3. A multi-scale system as defined in claim 1 further comprising a graphic display and wherein the weight readouts are each independent locations on the graphic display.

4. A multi-scale system as defined in claim 1 further comprising a payment interface element by which the payment can be made.

5. A multi-scale system as defined in claim 1 further comprising a base element for maintaining the at least two scale element at no greater than a distance of one foot from one another and for maintaining a substantially fixed orientation with respect to one another.

6. A multi-scale system as defined in claim 5 in which the base element includes at least one ramp element adapted to facilitate placement of an object onto and off of a respective scale platform without requiring a user of the system to lift the full weight of the object.

7. A multi-scale system as defined in claim 1 in which each of the scale platforms includes a cage element affixed thereto, each cage element being adapted to provide lateral support and stabilization for the object placed on the respective scale platform.

8. A multi-scale system as defined in claim 7 in which each cage element acts as a substrate upon which information is displayed to a user or potential user of the system.

9. A multi-scale system as defined in claim 8 in which the information includes advertising, system usage instructions or system branding.

10. A system as defined in claim 1 further comprising an auxiliary display element configured to display auxiliary information including one or more of carrier-specific weight regulations, carrier-specific pricing structure, flight schedules, advertisement, and payment information.

11. A system as defined in claim 10 in which the auxiliary information further includes currency conversion information.

12. A system as defined in claim 1 in which the system further includes a network connection by which the system can be remotely controlled, monitored and updated from an off-site location.

13. A system as defined in claim 1 in which the activation period is extendable by an extension period by way of a second payment being made during the activation period.

14. A multi-scale system comprising:
at least two scale elements, each scale element having a scale platform and being adapted to independently sense the weight of respective objects placed on the respective scale platforms, each of the scale platforms including a cage element affixed thereto, each cage element being adapted to provide lateral support for an object placed on the respective scale platform;
at least two weight readouts, each weight readout being operatively associated with a respective one of the at least two scale elements;
control logic configured to activate the scale elements and the weight readouts concurrently throughout an activation period as a result of a single transaction; and
a base element for maintaining the at least two scale elements at no greater than a distance of one foot from one another and for maintaining a substantially fixed orientation with respect to one another.

15. A system as defined in claim 14 in which the system further includes a network connection by which the system can be remotely controlled, monitored and updated from an off-site location.

16. A system as defined in claim 14 in which the activation period is extendable by an extension period by way of a second transaction being made during the activation period.

17. A multi-scale method comprising:
acquiring a multi-scale system having:
(a) two scale elements, each scale element having a scale platform, the scale elements being adapted to independently sense the weight of two pieces of luggage placed on the respective scale platforms;
(b) two weight readouts, each weight readout being operatively associated with a respective one of the scale elements; and
(c) control logic configured to activate the scale elements and the weight readouts concurrently throughout an activation period as a result of a single payment; and
operating the system within a travel service facility, wherein said system is located for allowing a traveler to use the system to simultaneously independently weigh the pieces of luggage and redistribute the contents therebetween prior to checking the pieces of luggage with any travel service within the travel service facility.

18. A system as defined in claim 17 in which the system includes a network connection by which the system can be remotely controlled, monitored or updated from a location remote from the travel service facility.

19. A method as defined in claim 17 in which the system includes an auxiliary display element, and the method further comprises displaying auxiliary information on the auxiliary display element, the auxiliary information including one or more of carrier-specific weight regulations, carrier-specific pricing structure, flight schedules, advertisement, and payment information.

20. A multi-scale method as defined in claim 17 in which each of the scale platforms include a cage element affixed thereto, the cage elements being adapted to provide lateral support and stabilization for the piece of luggage placed on the respective scale platform.
